(19) United States
(12) Patent Application Publication
(10) Pub. No.: US 2024/0418011 A1
(43) Pub. Date: Dec. 19, 2024

(54) REMOTE-CONTROLLED DEADBOLT LOCKING DEVICE WITH MANUAL OVERRIDE AND SAFETY MECHANISMS

(71) Applicant: Stephen Timothy Atkins, Antelope, CA (US)

(72) Inventor: Stephen Timothy Atkins, Antelope, CA (US)

(21) Appl. No.: 18/745,964

(22) Filed: Jun. 17, 2024

Related U.S. Application Data
(60) Provisional application No. 63/521,352, filed on Jun. 16, 2023.

(51) Int. Cl. E05B 63/00; E05B 47/00

(52) U.S. Cl. CPC E05B 63/0004; E05B 47/0012; E05B 63/0017; E05B 2047/0017

(57) ABSTRACT

The present invention relates to a smart deadbolt locking device that fits over an existing deadbolt knob, providing both remote control and manual operation. The device features spring-loaded fingers to maintain the deadbolt's locked or unlocked state, a bidirectional electronically controlled motor for engaging and disengaging the lock, and a wireless communication module for remote operation. It includes a manual override mechanism with release buttons, a manual slide stopper for physical locking and power cutoff, and an electronically controlled physical stopper with a no-power fail-open configuration for safety. The device is designed for easy installation and integrates seamlessly with modern smart home systems, enhancing security and convenience.

### CROSS REFERENCE TO RELATED APPLICATIONS

The present application is U.S. Non-Provisional Patent Application which claims the priority benefit from U.S. Provisional Application Ser. No. 63/521,352 filed Jun. 16, 2023, titled “The Deadbolter”, all of which are hereby expressly incorporated by reference in their entirety.

### FIELD OF THE INVENTION

The present invention relates to the field of door locking mechanisms, specifically to a smart device designed to control and secure deadbolt locks. The device incorporates remote control capabilities, manual override features, and safety mechanisms to ensure reliable operation and enhance security.

### BACKGROUND

A deadbolt is a locking mechanism distinct from a spring bolt lock because it cannot be moved to the open position except by rotating the lock cylinder with a key. Deadbolts provide an extra layer of security to doors, making them more resistant to unauthorized entry compared to standard spring bolt locks. They are commonly used in residential homes, commercial establishments, and hotels to secure rooms and prevent unauthorized access.

Deadbolts are crucial for enhancing the security of premises. They are typically used in combination with other types of locks to provide a more comprehensive locking system. Deadbolts are valued for their robustness and the security they provide against break-ins and forced entry.

Traditional deadbolts are manually operated and require physical presence to lock or unlock. This manual operation can be inconvenient, especially in scenarios where remote access control is desired. Additionally, existing deadbolt systems often lack advanced security features such as remote monitoring and control, making them less suitable for modern security needs. Given the limitations of traditional deadbolt systems, there is a need for an advanced deadbolt locking device that offers remote control capabilities, enhanced safety features, and manual override options. Such a device would provide greater convenience, improve security, and integrate seamlessly with modern smart home and security systems. The development of a smart deadbolt device addresses these needs by enabling users to control and monitor their locks remotely while ensuring that manual operation remains possible for safety and reliability.

### SUMMARY

The dead bolter is a smart locking device designed to fit over existing deadbolt knobs, providing the ability to remotely control and monitor the deadbolt's status (locked or unlocked). It utilizes spring-loaded fingers to interfere with the knob's turning mechanism, ensuring it remains in its current state. The device is designed to be both manually operable and remotely controlled via wireless signals.

The key features of the dead bolter include spring-loaded fingers that surround and interfere with the deadbolt knob's turning mechanism, maintaining the deadbolt's state (either locked or unlocked). For remote operation, the device utilizes wireless communication for remote control and includes power electronics to support wireless features, along with a bidirectional electronically controlled motor for moving the pin cylinder.

For manual operation, the device has two release buttons to manually turn it and a manual slide stopper to physically lock the device and cut off power to the motor. Safety and fail-safe mechanisms include an electronically controlled physical stopper with a no-power fail-open configuration and an option for an electronically controlled center motor or recatching center pin for similar effects.

In terms of design and installation, the dead bolter uses the same installation method as traditional non-smart versions. Spring pins are held in place with two circular plates, one geared inside a square frame on a center pin. It has a protective cover over gears and internal components, excluding the pins. Wiring runs within the interior of the square exterior, and there is an externally accessible wireless antenna connection for shielded or metal doors.

Aesthetic and structural design features include a skeleton frame with an optional decorative exterior. The device does not interfere with proper door fittings, and the processor controller and wireless controller transmitter/receiver locations are adjustable based on design constraints.

The operation of the dead bolter device begins with its installation, which involves placing the device over the existing deadbolt knob and securing it vertically under the deadbolt, locking it in place. Once installed, the device can be operated either manually or remotely, offering versatile control over the deadbolt lock. The core mechanism of the dead bolter involves spring-loaded fingers that surround the deadbolt knob, interfering with its turning mechanism to ensure it remains in its current state, whether locked or unlocked. For manual operation, users can depress two release buttons on the device to unlock the spring-loaded fingers, allowing the deadbolt knob to be turned manually. Additionally, a manual slide stopper located at the bottom of the device can be used to physically lock the dead bolter in place and cut power to the motor, ensuring the device remains securely in its intended position without consuming power. This manual override is particularly useful in scenarios where remote control may be unavailable or in emergencies where quick and direct access is necessary. For remote operation, the dead bolter is equipped with power electronics and a bidirectional electronically controlled motor that moves the pin cylinder to engage or disengage the locking mechanism. Users can control the device wirelessly via a transmitter-receiver system, sending signals to lock or unlock the deadbolt from a distance. This remote capability is facilitated by an externally accessible wireless antenna connection, which can be used with an external antenna to ensure reliable communication, even with shielded or metal doors. Safety features are integrated into the dead bolter to ensure reliable operation. The device includes an electronically controlled physical stopper with a no-power fail-open configuration, ensuring that the deadbolt can still be operated manually in the event of a power failure. This safety mechanism prevents the device from becoming a barrier in emergency situations. The protective cover over the gears and internal components, excluding the pins, adds an extra layer of security and durability to the device.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIGS. 1-7 are diagrams that illustrate a dead bolter device and its configuration in various views, in accordance with an embodiment of the present subject matter.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the FIGURES may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components or set-ups, which provides an improvised version of the dead bolter device. The dead bolter device combines the robustness of traditional deadbolt locks with the convenience of modern smart home technology. Its ability to be manually overridden ensures reliability, while its remote-control features provide enhanced convenience and security, making it a comprehensive solution for modern access control needs. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items.

The present invention will now be described with reference to the accompanying drawings which should be regarded as merely illustrative without restricting the scope and ambit of the present invention.

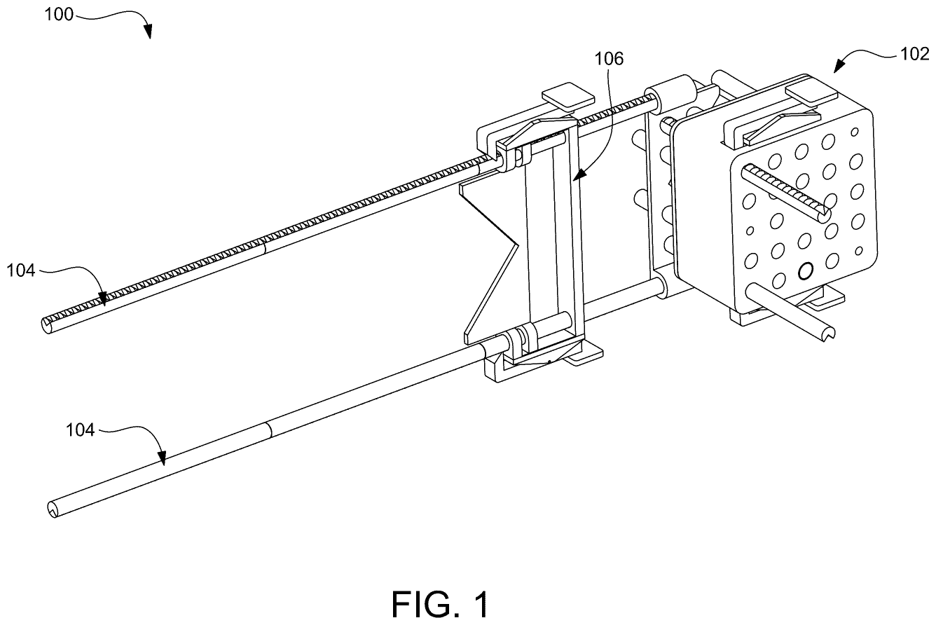

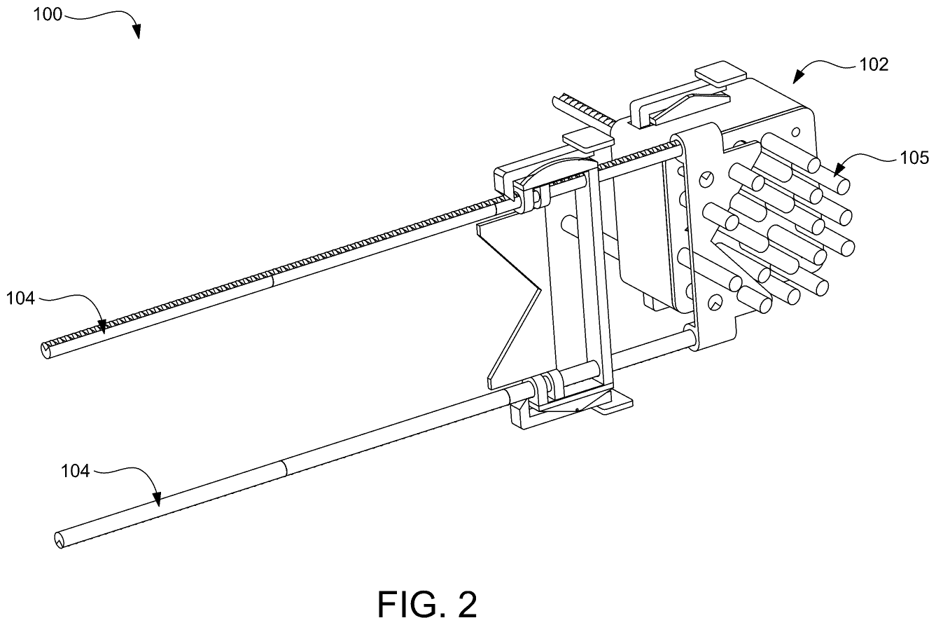

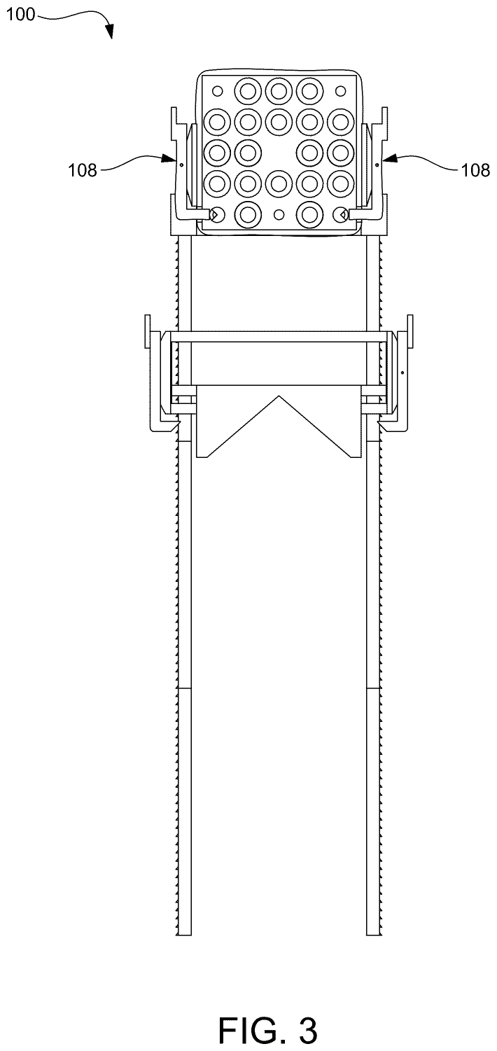

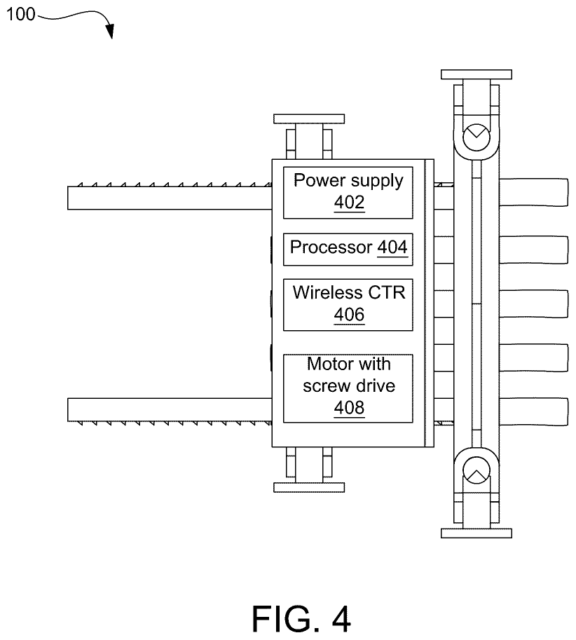

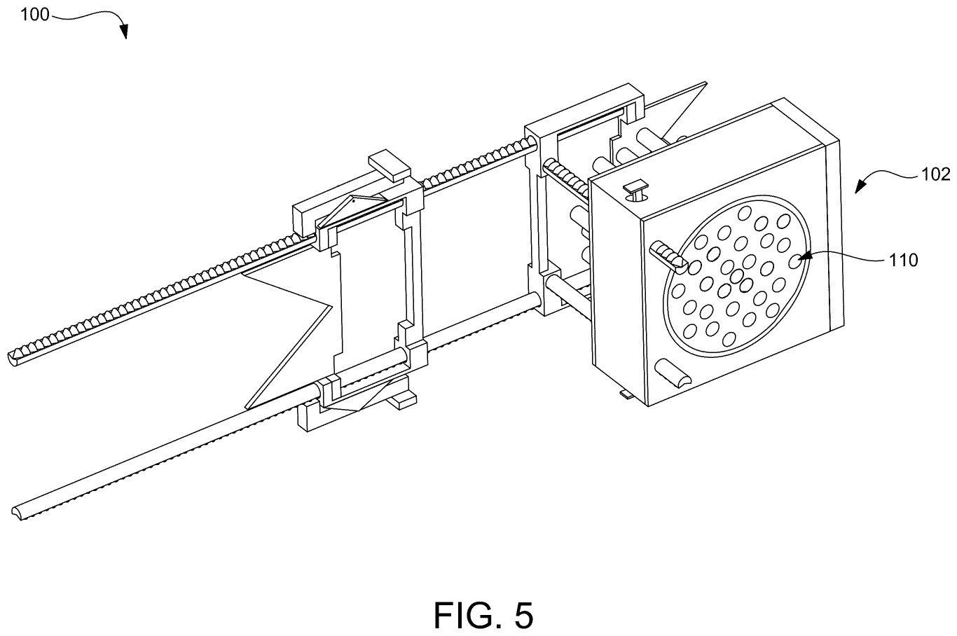

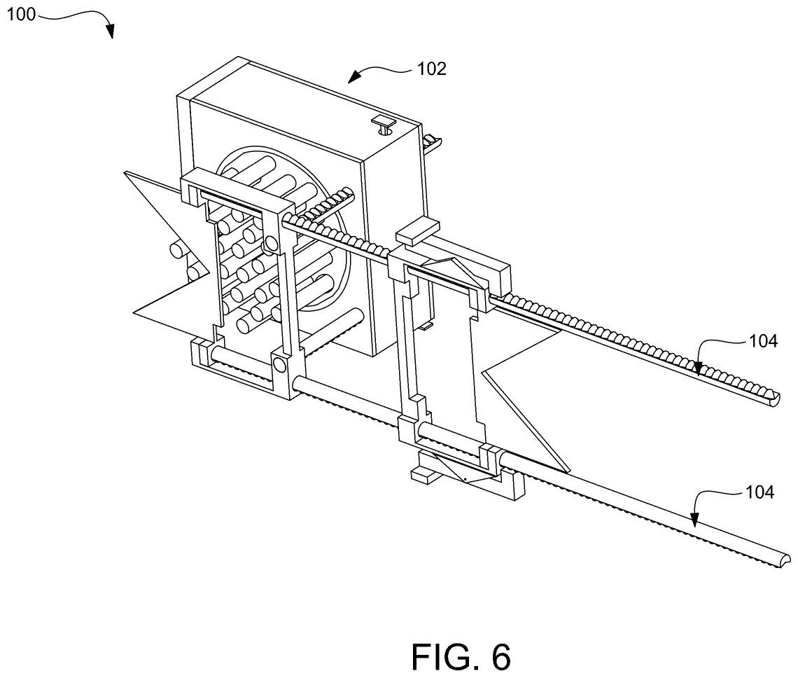

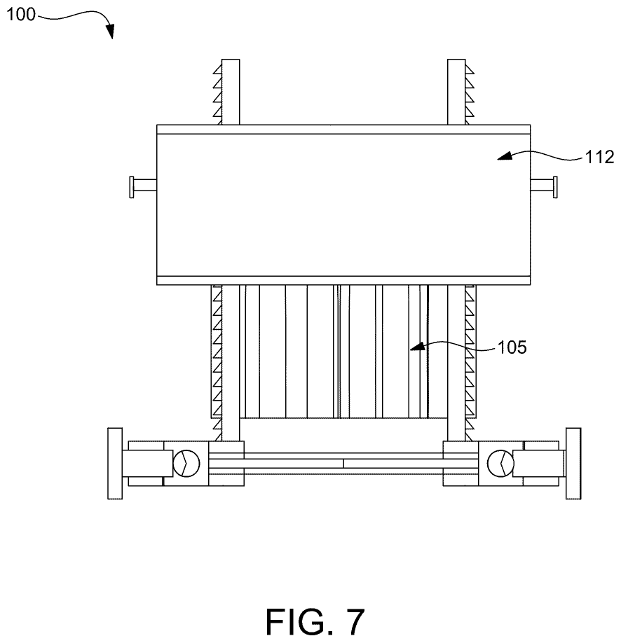

FIGS. 1-7 are diagrams that illustrate a dead bolter device 100 and its configuration in various views, in accordance with an embodiment of the present subject matter.

The dead bolter device, referenced as numeral 100, is depicted in various views in FIGS. 1-7. The device 100 comprises a locking head unit 102 and a body 104, both supported by frames 106. Springs 105 are incorporated within the structure to facilitate the engagement and disengagement of the locking mechanism. Additionally, a latch 108 is located on the sides of the device, providing a manual locking option. The device features pin holes 110, which are essential for securing the components and aligning them properly during installation. Metallic plates 112 are also shown, providing structural integrity and support to the device. The electrical and electronic components of the dead bolter device 100 include a power supply 402, which powers the entire system. A processor, or controller, 404 is used to manage the operations of the device, including processing signals and controlling the locking mechanism. The wireless controller, transmitter, and receiver (CTR) 406 enable remote communication with the device, allowing users to lock or unlock the deadbolt from a distance. The motor with a screw drive 408 is responsible for the mechanical movement required to engage or disengage the locking head unit 102. This motor is controlled by the processor and can operate bidirectionally to either lock or unlock the deadbolt as needed. Together, these components create a robust and secure locking system that combines the convenience of remote operation with the reliability of manual overrides and physical security measures. The design ensures easy installation and integration with existing deadbolt mechanisms while enhancing the security and functionality of traditional locks.

In an embodiment, the dead bolter device 100, is designed to fit over a deadbolt knob, locking it in either an opened or closed state. This locking mechanism is achieved through the use of spring-loaded fingers that surround and interfere with the knob's turning, ensuring it stays in its current position. The device can be operated remotely via a wireless signal, providing users the ability to lock and unlock any deadbolt from a distance. Key features of the wireless version include power electronics, wireless communication capabilities, and an actuator or motor. The dead bolter device is particularly advantageous for comprehensive remote control and monitoring of all rooms, including those with doors that only lock from the inside, such as in hotels. It operates as a “place it and leave it” device, installed in the same manner as traditional, non-smart versions using the same spring pins. These pins are secured by two circular plates, with one geared inside a square frame on a center pin. The pin cylinder of the dead bolter device can be moved either by a bidirectional electronically controlled motor, which is also geared, or manually by depressing two release buttons and turning the device's turn handle or pressing the open button. A critical safety feature of the dead bolter device is the electronically controlled physical stopper, which has a no-power fail-open configuration to ensure safety. This means that if power is lost, the device will default to an open state, allowing manual operation of the deadbolt. Additionally, an electronically controlled center motor or a recatching center pin can achieve a similar fail-safe effect. For added security, a manual slide stopper is located at the bottom of the device, physically locking it in place and cutting power to the motor. The device's processor controller and wireless controller transmitter-receiver can be positioned flexibly, provided their placement does not interfere with the device's movement or increase its dimensions to a point where it affects proper door fittings. All internal components, including gears, are protected by a cover, with the exception of the pins, to ensure durability and security. The dead bolter's exterior design can be purely decorative, incorporating a skeleton frame to house the internal components. Importantly, the device does not alter the fundamental mechanism of the deadbolt's locking and immobilization, maintaining the integrity of the original lock. All wiring within the dead bolter device runs inside the square exterior of the device. For environments with shielded or metal doors, there is an externally accessible wireless antenna connection point, allowing the use of an external antenna to ensure reliable wireless communication. This comprehensive design ensures that the dead bolter device enhances traditional deadbolt security with modern technological conveniences, without compromising on safety or usability.

In some exemplary embodiments, the dead bolter device comprises a locking head unit and a support frame. The locking head unit is constructed with two 2″×2″ metal squares, each featuring 24 equally separated holes arranged in a 5×5 grid without a hole in the center. These holes are designed to have 2″ spacers connecting the plates, allowing passthrough for the support frame. The unit includes a pin metal rod with a 1″ compression spring and a stopper, ensuring secure engagement. The support frame consists of three main components: the head guide, the body, and the foot assembly. The head guide is a 2″×2.5″ plate with a 1″ “V” cut out on each side, facilitating alignment and secure placement. It features 4″ guideposts with compression springs that slide into 2-3 of the holes, along with additional holes for connecting the body locking mechanism. The body of the device is a 2″ metal tube, though the size may vary depending on the application, such as for deadbolts, handle single unit combinations, and irregular spaced locks. The body has two holes for connecting it to the head unit, and the foot assembly slides inside this body. The foot consists of a 2″ solid metal rod, with its size adjustable based on application needs. This rod has a tapped hole at the end to connect a security ribbon via a fastener. The door handle holder is a 4″ solid rod with a 30-degree bend and a 2″ threaded connector that fits into a 1.75″ deep threaded hole, allowing for height adjustment to accommodate various doors.

In one example, to use the smart dead bolter, place the device over the door handle and extend it vertically under the deadbolt, securing it in place. Once the deadbolt is locked from either inside or outside, the motor can move the head unit to engage or disengage the dead bolter, providing remote control over the locking mechanism. In another example, once assembled, the door holder is placed over the door handle and the head guide, with the “V” cut positioned behind the deadbolt turn knob. The locking head unit is then pressed against the deadbolt and locked using the latch, completely immobilizing the deadbolt from turning. This ensures that the deadbolt cannot be manipulated, providing an added layer of security.

In a specific embodiment of the present invention, the smart deadbolt locking device may feature a housing specifically designed to be placed over an existing deadbolt knob. This housing encloses and protects the internal mechanisms of the device, ensuring durability and security. Inside the housing, spring-loaded fingers are strategically positioned to engage with the deadbolt knob. These fingers interfere with the knob's rotation, effectively maintaining the deadbolt in its current state, whether locked or unlocked. This ensures that the deadbolt remains secure until a deliberate action is taken to change its state. A key component within the housing is the bidirectional electronically controlled motor, which is responsible for moving a pin cylinder to engage or disengage the deadbolt knob. This motor allows for precise control over the deadbolt's position and facilitates the transition between locked and unlocked states based on user input. The motor's bidirectional capability ensures that it can handle both locking and unlocking actions efficiently. The device is further equipped with a wireless communication module, which is configured to receive remote control signals. This module enables users to operate the motor remotely, providing the convenience of controlling the deadbolt from a distance. The wireless communication feature is crucial for integrating the deadbolt into modern smart home systems, allowing for enhanced security and ease of use. For situations where manual operation is necessary, the device includes a manual override mechanism. This mechanism comprises two release buttons that, when depressed, disengage the spring-loaded fingers. This allows the user to manually rotate the deadbolt knob, providing a fallback option in case the electronic components fail or if manual operation is preferred. Additionally, a manual slide stopper is located at the bottom of the housing. This stopper can be used to physically lock the device in place and cut power to the motor. This feature is particularly useful for securing the device during maintenance or in scenarios where the motor's operation needs to be temporarily disabled. To enhance safety, the device may include an electronically controlled physical stopper with a no-power fail-open configuration. This means that in the event of a power failure, the device defaults to an open state, allowing for manual operation of the deadbolt knob. This fail-safe mechanism ensures that users can always access the lock manually, providing peace of mind and ensuring security even during power outages.

Further, in an embodiment, the wireless communication module of the smart deadbolt locking device may include an externally accessible wireless antenna connection point designed for use with an external antenna. This feature is particularly important for installations involving shielded or metal doors, where standard wireless signals might be obstructed. Shielded or metal doors can significantly reduce the effectiveness of wireless signals due to their materials' tendency to block or interfere with radio frequencies. To address this issue, the externally accessible wireless antenna connection point allows for the attachment of an external antenna, which can be positioned outside the obstructing materials. By doing so, the device ensures reliable communication between the smart deadbolt and the remote-control system, maintaining seamless operation even in challenging environments. This connection point is designed to be easily accessible, enabling users to attach or detach the external antenna as needed without requiring extensive modifications to the door or the locking device. The ability to connect an external antenna ensures that the smart deadbolt can maintain a strong and consistent wireless connection, enhancing its reliability and functionality in various installation scenarios. The wireless communication module may support various communication protocols compatible with common smart home systems. This compatibility ensures that the device can seamlessly integrate into existing smart home ecosystems, providing users with enhanced convenience, control, and interoperability.

Further, in an embodiment, the housing of the smart deadbolt locking device may include protective covers over the gears and internal components, excluding the pins, to enhance both security and durability. These protective covers are designed to shield the intricate mechanisms inside the device from potential damage and environmental factors. By covering the gears and other internal components, the protective covers prevent dust, dirt, and debris from entering the device, which could otherwise cause wear and tear or interfere with its smooth operation. This protection ensures that the device maintains its functionality and reliability over time, even in harsh conditions. Additionally, the protective covers provide a layer of security by safeguarding the internal mechanisms from tampering or unauthorized access. This is crucial in maintaining the integrity of the locking mechanism, ensuring that it cannot be easily manipulated or bypassed. The decision to exclude the pins from these protective covers allows for necessary interaction with the locking mechanism without compromising the device's overall security and durability. The pins remain accessible for installation and manual operation, ensuring that users can still engage or disengage the lock as needed.

Further, in an embodiment, the smart deadbolt locking device incorporates a processor controller within the housing, which is configured to manage the operations of both the motor and the wireless communication module. This processor controller acts as the central processing unit for the device, coordinating various functions to ensure seamless operation. The processor controller's primary role is to control the bidirectional electronically controlled motor. It processes input signals received from the wireless communication module or manual override mechanisms and translates these signals into precise motor actions. For example, when a remote lock or unlock command is received via the wireless module, the processor interprets this command and activates the motor to move the pin cylinder, accordingly, engaging or disengaging the deadbolt. Additionally, the processor controller handles the wireless communication module's functions. It processes the incoming remote-control signals and ensures that these signals are correctly interpreted and executed. This includes commands for locking, unlocking, and possibly other functions such as status updates or alerts. The controller ensures that the device responds promptly and accurately to remote commands, providing users with reliable and efficient remote access to their locks. By integrating the processor controller within the housing, the device maintains a compact and streamlined design, ensuring that all electronic components are protected and efficiently managed within a single enclosure. This integration also enhances the device's reliability, as the processor can quickly and effectively coordinate the operations of both the motor and the wireless communication module, ensuring smooth and synchronized performance.

Further, in an embodiment, the smart deadbolt locking device utilizes spring-loaded fingers to engage with and control the deadbolt knob. These spring-loaded fingers are held in place by two circular plates, which are essential for the proper functioning and stability of the mechanism. One of these circular plates is geared inside a square frame on a center pin, providing a structured and secure arrangement. The two circular plates serve as the primary support structure for the spring-loaded fingers. They are designed to align the fingers accurately and ensure they are positioned correctly to engage with the deadbolt knob. The spring-loaded fingers are attached to these plates in such a way that they can exert the necessary force to interfere with the rotation of the knob, effectively locking or unlocking it. One of the circular plates is geared, meaning it has teeth or grooves that interact with corresponding components within the square frame. This gearing mechanism is crucial for the controlled movement of the spring-loaded fingers. The geared plate rotates or moves within the square frame, which is anchored by a center pin. This configuration ensures that the movement of the spring-loaded fingers is precise and coordinated. The square frame provides a rigid and stable enclosure for the geared plate and the spring-loaded fingers. The center pin acts as a pivot point, allowing the geared plate to rotate or move within the frame. This movement is essential for the engagement and disengagement of the spring-loaded fingers with the deadbolt knob. When the device receives a command to lock or unlock, the geared plate moves the fingers into or out of position, interfering with the knob's rotation and thus controlling the deadbolt's state.

Further, in an embodiment, the smart deadbolt locking device features a pin cylinder that can be moved manually, providing users with an alternative method of operation in addition to the electronic controls. This manual operation is facilitated by two release buttons and a turn handle or an open button, ensuring that users can still control the deadbolt in situations where electronic control might not be feasible or preferred. To move the pin cylinder manually, users first depress the two release buttons located on the device. These release buttons disengage the locking mechanism of the spring-loaded fingers that normally hold the pin cylinder in place. By pressing these buttons, the internal components that restrict the movement of the pin cylinder are temporarily disabled, allowing the user to manually manipulate the deadbolt. Once the release buttons are depressed, the user can then turn the device's turn handle or press an open button to move the pin cylinder. The turn handle provides a tactile, manual control option, similar to how traditional deadbolts are operated. By turning the handle, the user can rotate the pin cylinder to engage or disengage the deadbolt, effectively locking or unlocking the door. This method mimics the familiar motion of operating a standard deadbolt, ensuring case of use. Alternatively, the device may also feature an open button, which provides a straightforward push-button control for manual operation. When the open button is pressed, it moves the pin cylinder in the desired direction, either engaging or disengaging the deadbolt. This button can be particularly useful for users who prefer a simple, single-action mechanism for manual control. The inclusion of both the turn handle and the open button offers flexibility and convenience, allowing users to choose their preferred method of manual operation. This manual control is particularly valuable in situations where the electronic components might be compromised, such as during a power outage or a malfunction. It ensures that the user can always access the deadbolt and secure their property, maintaining the overall security and functionality of the locking device.

Further, in an embodiment, the smart deadbolt locking device is equipped with a bidirectional electronically controlled motor that not only engages and disengages the deadbolt lock but also provides feedback on the lock's status to a remote user. This feedback functionality is a crucial aspect of the device, enhancing its utility and reliability in remote access scenarios. The bidirectional motor is capable of moving the pin cylinder in both directions, either locking or unlocking the deadbolt. When a remote user sends a command to lock or unlock the door, the motor responds accordingly, ensuring that the deadbolt moves to the desired position. The motor's bidirectional capability ensures precise and controlled movement, which is essential for the accurate operation of the locking mechanism. In addition to its movement capabilities, the motor is integrated with sensors and electronic feedback mechanisms that monitor the position and status of the deadbolt. These sensors detect whether the deadbolt is in the locked or unlocked position and communicate this information back to the processor controller within the device. The processor then processes this data and relays it to the wireless communication module. The wireless communication module transmits the status information to the remote user through the device's associated smart home or security system. This transmission can occur via various communication protocols, such as Wi-Fi, Bluetooth, or other wireless technologies. The user, typically through a smartphone app or web interface, receives real-time updates on the status of the deadbolt. This feedback ensures that the user is always aware of whether the door is securely locked or unlocked, providing peace of mind and enhancing security management. This feedback loop is essential for several reasons: (1) Users can confirm that their lock commands have been successfully executed, ensuring the door is secured or accessible as needed. (2) Continuous updates on the lock status allow users to monitor their property's security from anywhere, enhancing overall control and surveillance. (3) If there is an issue with the locking mechanism, such as a jam or misalignment, the feedback system can alert the user to the problem, prompting timely intervention. (4) The status feedback allows for integration with other smart home devices, enabling automated actions based on the lock status (e.g., turning off lights when the door is locked).

Further, in an embodiment, the smart deadbolt locking device features an actuator within its housing, which is specifically configured to assist in the engagement and disengagement of the spring-loaded fingers. This actuator plays a critical role in the overall functionality and efficiency of the device, ensuring smooth and reliable operation. The spring-loaded fingers are designed to engage with the deadbolt knob, preventing it from turning and thereby maintaining the deadbolt in either a locked or unlocked state. The actuator aids in the precise movement of these fingers, enhancing the device's ability to secure or release the deadbolt knob as needed. When a command is issued to lock or unlock the deadbolt, either manually or remotely, the actuator receives a signal from the processor controller. This signal triggers the actuator to perform its function. The actuator's primary role is to apply the necessary force to move the spring-loaded fingers into or out of engagement with the deadbolt knob. In the locking process, the actuator ensures that the spring-loaded fingers are pushed into position to interfere with the knob's rotation, effectively securing the deadbolt. Conversely, during the unlocking process, the actuator retracts the fingers, allowing the knob to turn freely and disengage the lock. This movement is essential for the accurate and reliable functioning of the deadbolt mechanism.

Further, in an embodiment, the housing of the smart deadbolt locking device is thoughtfully designed with a skeleton frame, which provides structural integrity and protection for the internal components, and an optional decorative exterior, which enhances its aesthetic appeal without compromising functionality. The skeleton frame serves as the foundational structure of the device. This frame is typically constructed from robust materials such as metal or high-strength plastic, ensuring that it can withstand physical stress and protect the internal mechanisms from damage. The skeleton frame's primary function is to support and securely hold all the essential components, including the spring-loaded fingers, bidirectional motor, actuator, and various electronic parts such as the processor controller and wireless communication module. The design of the skeleton frame is optimized for durability and efficiency. It offers a rigid framework that maintains the alignment and proper functioning of all internal parts. Additionally, the frame is designed to facilitate easy assembly and disassembly, allowing for straightforward installation and maintenance of the device. The open structure of the skeleton frame also aids in heat dissipation, preventing overheating of the electronic components. Covering the skeleton frame is an optional decorative exterior. This exterior casing is designed to enhance the visual appeal of the device, making it suitable for various interior design styles and preferences. The decorative exterior can be customized in different colors, finishes, and materials, such as brushed metal, polished plastic, or even wood veneer, to match the door and its surroundings. While the decorative exterior adds an aesthetic dimension to the smart deadbolt locking device, it is also designed to be practical. It provides an additional layer of protection against dust, dirt, and minor impacts, further safeguarding the internal components. However, the exterior casing is optional, meaning that users can choose to install the device with or without it, depending on their aesthetic and functional needs.

Further, in an embodiment, the smart deadbolt locking device incorporates power electronics that are meticulously configured to manage the power supply to both the motor and the wireless communication module. These power electronics are essential for ensuring the efficient and reliable operation of the device by regulating the flow of electricity to its critical components. The power electronics are designed to connect to a suitable power source, which could be batteries, an external power adapter, or a combination of both. This connection ensures that the device has a consistent and reliable supply of electricity to perform its functions. One of the primary functions of the power electronics is to regulate the voltage supplied to the motor and the wireless communication module. Different components within the device may require different voltage levels to operate optimally. For instance, the motor might need a higher voltage for robust operation, while the wireless module may require a lower, more stable voltage. The power electronics ensure that each component receives the appropriate voltage, preventing damage and ensuring efficient performance. Besides voltage regulation, the power electronics also manage the current flow to various components. This involves ensuring that the motor receives sufficient current for its operation without overloading, and that the wireless module gets a steady current to maintain reliable communication. Proper current management helps in preventing overheating and potential component failure. If the device uses batteries as a power source, the power electronics include battery management systems. These systems monitor the battery levels, optimize charging and discharging cycles, and provide indicators or alerts when the battery needs to be replaced or recharged. This ensures that the device remains operational without unexpected power losses. The power electronics also distribute power efficiently between the motor and the wireless communication module. When a remote command is received, the system prioritizes power to the motor to execute the locking or unlocking action. Simultaneously, it ensures that the wireless module remains powered to communicate status updates and receive further commands.

Further, in an embodiment, the smart deadbolt locking device is designed for seamless installation using the same spring pins as the original non-smart deadbolt version. This compatibility with existing hardware simplifies the upgrade process, making it easy for users to enhance their security systems without requiring extensive modifications or additional tools. Spring pins, also known as roll pins or tension pins, are commonly used in traditional deadbolt locks to secure various components in place. These pins are cylindrical and slightly oversized, creating a tension fit when inserted into a corresponding hole. The smart deadbolt locking device utilizes these same spring pins, ensuring that it can be directly installed onto the existing deadbolt setup.

Further, in an embodiment, the smart deadbolt locking device incorporates a bidirectional motor that is specifically geared for fine control over the deadbolt locking mechanism. This motor is a crucial component that enhances the precision and reliability of the locking and unlocking processes, ensuring smooth and accurate operation. A bidirectional motor is capable of rotating in both clockwise and counterclockwise directions. In the context of the smart deadbolt locking device, this bidirectional capability allows the motor to both engage and disengage the deadbolt lock. The motor's movement is finely tuned through a gearing system, which translates the motor's rotation into the precise movement required to control the deadbolt.

Further, in an embodiment, the smart deadbolt locking device includes a recatching center pin mechanism that provides additional control over the deadbolt lock, enhancing both security and functionality. This mechanism works in conjunction with the other components of the device to ensure precise and reliable operation. The recatching center pin is a pivotal component located at the center of the locking mechanism. It plays a crucial role in engaging and securing the deadbolt when the lock is activated, and in disengaging it when the lock is deactivated. The recatching feature of the center pin provides enhanced control over the movement of the deadbolt. When the deadbolt is moved into the locked position by the bidirectional motor, the center pin “recatches” or re-engages to hold the deadbolt securely in place. This additional locking point ensures that the deadbolt remains stable and resistant to any attempts to force it open.

Further, in an embodiment, the smart deadbolt locking device includes a manual slide stopper that serves a dual purpose: it acts as a physical lock to secure the device in place and functions as a safety lock to prevent the accidental engagement of the motor. This feature enhances both the safety and reliability of the device, providing users with greater control over its operation. The primary function of the manual slide stopper is to act as a physical lock that secures the device in place. When engaged, the slide stopper physically prevents the internal components of the device from moving, ensuring that the deadbolt remains locked or unlocked as desired. This mechanical locking is crucial for maintaining security, especially when the device is not in use or when performing maintenance. In addition to its role as a physical lock, the manual slide stopper also serves as a safety mechanism to prevent the accidental engagement of the motor. When the slide stopper is engaged, it interrupts the power supply to the motor, effectively disabling it. This ensures that the motor cannot be activated inadvertently, either by remote control signals or by accidental manual input. The safety lock feature of the manual slide stopper is particularly important in preventing unintended motor operations that could lead to mechanical wear, damage, or security breaches. For example, if the device is being handled during maintenance or if it is in a location where accidental activation is possible, engaging the slide stopper ensures that the motor remains inactive, thereby protecting the device and its surroundings. The manual slide stopper is designed to be user-friendly, allowing for quick and easy engagement and disengagement. Users can simply slide the stopper into position to lock the device and cut off power to the motor. This straightforward operation ensures that users can quickly secure the device when needed, without requiring complex procedures or tools. The manual slide stopper works in harmony with the manual override features of the smart deadbolt locking device. When the slide stopper is engaged, users can safely use the manual override mechanism (depressing the release buttons and turning the handle) without the risk of the motor being accidentally activated. This integrated design ensures seamless operation and enhances user confidence in the device's safety features.

The disclosed smart deadbolt locking device offers numerous advantages, making it an essential addition to modern home security systems. Its ability to integrate with common smart home protocols like Wi-Fi, Bluetooth, Zigbee, and Z-Wave ensures seamless compatibility with a wide range of smart home ecosystems, allowing for easy control via voice commands, smartphone apps, and other connected devices. The bidirectional motor provides precise control over the deadbolt, ensuring smooth and reliable locking and unlocking, while the manual override options ensure usability during power outages or technical issues. The device's safety features, such as the manual slide stopper and no-power fail-open configuration, enhance security by preventing accidental engagement and ensuring manual operation is always possible. In terms of applications, the smart deadbolt locking device is versatile and suitable for various settings, including residential homes, rental properties, and commercial buildings. It provides homeowners with remote access control, enabling them to lock or unlock doors from anywhere, monitor the status of their locks in real-time, and integrate the lock with other smart home devices for automated routines. For rental properties, it offers the convenience of remote management, allowing property owners to grant or revoke access without needing to be physically present. In commercial settings, the device can enhance security by providing controlled access to restricted areas, integrating with existing security systems, and offering real-time alerts for any unauthorized attempts to access secured areas. Overall, the smart deadbolt locking device combines advanced technology with practical features, making it an ideal solution for enhancing security and convenience across various applications.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the claims. Thus, it is intended that the present invention cover the modifications and variations of this invention, provided they are within the scope of the claims and their equivalents.

What is claimed is:

1. A smart deadbolt locking device comprising:
a housing configured to be placed over a deadbolt knob;
spring-loaded fingers within the housing, configured to engage and interfere with the rotation of the deadbolt knob, maintaining it in a locked or unlocked state;
a bidirectional motor within the housing, configured to move a pin cylinder to engage or disengage the deadbolt knob;
a manual override mechanism comprising two release buttons configured to disengage the spring-loaded fingers for manual operation of the deadbolt knob; and
a manual slide stopper located at the bottom of the housing, configured to physically lock the device in place and cut power to the motor.

2. The smart deadbolt locking device of claim 1, wherein the housing includes protective covers over the gears and internal components, excluding the pins, for added security and durability.

3. The smart deadbolt locking device of claim 1, wherein the spring-loaded fingers are held in place by two circular plates, one of which is geared inside a square frame on a center pin.

4. The smart deadbolt locking device of claim 1, wherein the pin cylinder is movable manually by depressing the two release buttons and turning the device turn handle or pressing an open button.

5. The smart deadbolt locking device of claim 1, wherein the bidirectional motor is electronically controlled and is configured to provide feedback on the status of the deadbolt lock to a remote user.

6. The smart deadbolt locking device of claim 1, further comprising an actuator within the housing, configured to assist in the engagement and disengagement of the spring-loaded fingers.

7. The smart deadbolt locking device of claim 1, wherein the housing is designed with a skeleton frame and an optional decorative exterior.

8. The smart deadbolt locking device of claim 1, wherein the device can be installed using the same spring pins as the original non-smart deadbolt version.

9. The smart deadbolt locking device of claim 1, wherein the device includes a bidirectional motor geared for fine control over the deadbolt locking mechanism.

10. The smart deadbolt locking device of claim 1, further comprising a recatching center pin mechanism for additional control over the deadbolt lock.

11. The smart deadbolt locking device of claim 1, wherein the manual slide stopper also serves as a safety lock to prevent accidental engagement of the motor.

12. The smart deadbolt locking device of claim 1, further comprising a wireless communication module within the housing, configured to receive remote control signals for operating the motor.

13. The smart deadbolt locking device of claim 12, wherein the wireless communication module includes an externally accessible wireless antenna connection point for use with an external antenna for shielded or metal doors.

14. The smart deadbolt locking device of claim 13, further comprising a processor controller within the housing, configured to control the operation of the motor and the wireless communication module.

15. The smart deadbolt locking device of claim 14, further comprising power electronics configured to manage the power supply to the motor and wireless communication module.

16. The smart deadbolt locking device of claim 15, further comprising an electronically controlled physical stopper with a no-power fail-open configuration for safety, allowing manual operation of the deadbolt knob in the event of power failure.

17. The smart deadbolt locking device of claim 12, wherein the wireless communication module supports communication protocols compatible with common smart home systems.

18. A smart deadbolt locking device comprising:
a housing configured to be placed over a deadbolt knob;
spring-loaded fingers within the housing, configured to engage and interfere with the rotation of the deadbolt knob, maintaining it in a locked or unlocked state;
a bidirectional electronically controlled motor within the housing, configured to move a pin cylinder to engage or disengage the deadbolt knob;
a wireless communication module within the housing, configured to receive remote control signals for operating the motor;
a manual override mechanism comprising two release buttons configured to disengage the spring-loaded fingers for manual operation of the deadbolt knob;
a manual slide stopper located at the bottom of the housing, configured to physically lock the device in place and cut power to the motor; and
an electronically controlled physical stopper with a no-power fail-open configuration for safety, allowing manual operation of the deadbolt knob in the event of power failure.

19. A smart deadbolt locking device comprising:
a housing configured to be placed over a deadbolt knob;
spring-loaded fingers within the housing, configured to engage and interfere with the rotation of the deadbolt knob, maintaining it in a locked or unlocked state;
a bidirectional motor within the housing, configured to move a pin cylinder to engage or disengage the deadbolt knob;
a manual override mechanism comprising two release buttons configured to disengage the spring-loaded fingers for manual operation of the deadbolt knob;
a manual slide stopper located at the bottom of the housing, configured to physically lock the device in place and cut power to the motor; and
an electronically controlled physical stopper with a no-power fail-open configuration for safety, allowing manual operation of the deadbolt knob in the event of power failure.

20. The smart deadbolt locking device of claim 19, further comprising an actuator within the housing, configured to assist in the engagement and disengagement of the spring-loaded fingers.
